(19) United States
(12) Patent Application Publication
(10) Pub. No.: US 2015/0081313 A1
(43) Pub. Date: Mar. 19, 2015

(54) METHODS AND SYSTEMS FOR PHOTOVOLTAIC SITE INSTALLATION, COMMISSIOINING, AND PROVISIONING

(71) Applicant: SunEdison LLC, Beltsville, MD (US)

(72) Inventors: Andras Boross, Belmont, CA (US); Mike Quinn, Campbell, CA (US); Magnus Asbo, San Francisco, CA (US); Philip Regenie, Dublin, CA (US)

(21) Appl. No.: 14/027,840

(22) Filed: Sep. 16, 2013

(51) Int. Cl. G06Q 99/00; G06Q 50/08

(52) U.S. Cl. CPC G06Q 99/00; G06Q 50/08
USPC 705/1.1

(57) ABSTRACT

In one example, a method for installing a photovoltaic (PV) system including a plurality of PV components is described. The method includes receiving, by a computing device, a plurality of unique identifiers. Each unique identifier is associated with a different one of a plurality of PV components located at a site. The computing device compares the received unique identifiers to a list of the plurality of PV components in the PV system. The method includes associating each of the unique identifiers with a different component location on a representation of the PV system, and transmitting the associated unique identifiers and component locations to a gateway device of the PV system.

### FIELD

The field of the disclosure relates generally to photovoltaic (PV) site installation. More particularly, this disclosure relates to methods and systems for PV site installation, commissioning, and provisioning.

### BACKGROUND

Photovoltaic (PV) modules (also known as solar modules) convert solar energy into electrical energy. The electrical energy may be used directly at the site, converted for local use, and/or converted and transmitted to an electrical grid or another destination. Typically, a PV installation includes at least a plurality of PV modules logically or physically grouped together to form an array and one or more inverters that convert the direct current (DC) output of the PV modules to alternating current (AC) power.

The installation of a PV site is a relatively complicated and error prone process. Typically, one or more installers installs a PV system at a PV site based on a work order, which may have errors. A bundle of components is typically assembled by someone other than the installer (e.g., a component manufacturer, a distributor, a PV system retailer, etc.) and delivered to the PV site for installation. Ideally, the bundle includes all of the components for the PV system listed on the work order. However, the components included in the bundle delivered to a PV site may not be correct. For example, the bundle may be incomplete, include one or more incorrect components, or may actually be the wrong bundle for the site. Prior to installing the PV system, the installer must manually check to ensure that the correct bundle was delivered, manually check each component in the bundle against the work order, manually add components that are not part of the original bundle, manually delete components that cannot be installed, and manually collect the serial numbers of all of the components in the bundle or that are being used in the installation. In some known systems, the installer must contact (e.g., by telephone) a backend system (e.g., a technician/data entry personnel at a PV site management, monitoring, and/or data collection facility) to provide the serial numbers of the components, and identify which components (by serial number) correspond to which component in the PV system layout.

A gateway (sometimes referred to as a Data Logger or a Data Acquisition System) is often used to connect a PV system to the backend system. In some residential systems, the gateway uses the residential customer's broadband Internet connection to transmit and receive data to/from the backend system. To install the gateway, the installer either enters the customer's home and installs the gateway (including setup/connection to the customer's broadband internet connection), or provides instructions to the customer that explains the steps required to connect the gateway to the customer's broadband connection via a network router. These activities are time consuming, inconvenient, and sometimes unacceptable to the customer.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a method for installing a photovoltaic (PV) system including a plurality of PV components includes receiving, by a computing device, a plurality of unique identifiers. Each unique identifier is associated with a different one of a plurality of PV components located at a site. The computing device compares the received unique identifiers to a list of the plurality of PV components in the PV system. The method includes associating each of the unique identifiers with a different component location on a representation of the PV system, and transmitting the associated unique identifiers and component locations to a gateway device of the PV system.

In another aspect a computing device for facilitating installation of a photovoltaic (PV) system includes a plurality of PV components. The computing device includes a processor and a memory coupled to the processor. The memory includes computer-executable instructions that, when executed by the processor, cause the computing device to receive a plurality of unique identifiers, each unique identifier associated with a different one of a plurality of PV components located at a site, compare the received unique identifiers to a list of the plurality of PV components in the PV system, associate each of the unique identifiers with a different component location on a representation of the PV system, and transmit the associated unique identifiers and component locations to a gateway device of the PV system.

Another aspect of the present disclosure is a computer-readable storage device having non-transitory, computer-executable instructions embodied thereon. When executed by a computing device including a processor and a memory coupled to the processor, the computer-executable instructions cause the computing device to receive a plurality of unique identifiers. Each unique identifier is associated with a different one of a plurality of PV components located at a site. The computer-executable instructions cause the computing device to compare the received unique identifiers to a list of the plurality of PV components in the PV system, associate each of the unique identifiers with a different component location on a representation of the PV system, and transmit the associated unique identifiers and component locations to a gateway device of the PV system.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example photovoltaic (PV) module;

FIG. 2 is a cross-sectional view of the PV module shown in FIG. 1 taken along the line A-A;

FIG. 3 is a block diagram of an exemplary computing device;

FIG. 4 is a block diagram of an exemplary PV system;

FIG. 5 is a simplified diagram of an installation location for a PV system; and

FIGS. 6A and 6B are a flow diagram of a method of installing a PV system.

Like reference symbols in the various drawings indicate like elements.

### DETAILED DESCRIPTION

The embodiments described herein generally relate to photovoltaic (PV) systems. More particularly, the embodiments described herein relate to methods of installing and commissioning PV systems. Commissioning PV systems includes enabling communication, control, and data exchange between a PV system and any external data collection, control, and/or analysis system.

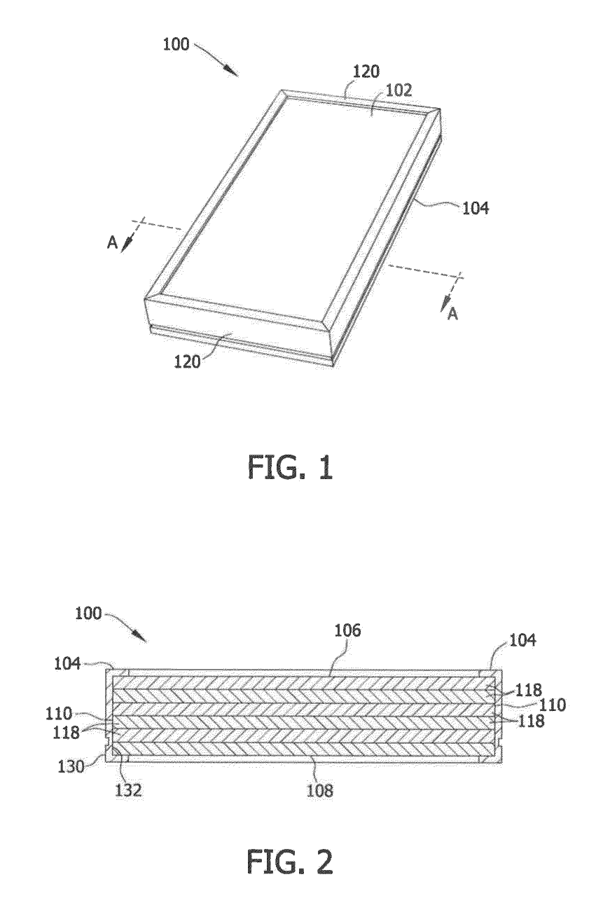

Referring initially to FIGS. 1 and 2, a PV module is indicated generally at 100. A perspective view of the PV module 100 is shown in FIG. 1. FIG. 2 is a cross sectional view of the PV module 100 taken at line A-A shown in FIG. 1. The PV module 100 includes a solar laminate 102 (also referred to as a PV laminate) and a frame 104 circumscribing the solar laminate 102.

The solar laminate 102 includes a top surface 106 and a bottom surface 108 (shown in FIG. 2). Edges 110 extend between the top surface 106 and the bottom surface 108. In this embodiment, the solar laminate 102 is rectangular shaped. In other embodiments, the solar laminate 102 may have any suitable shape.

As shown in FIG. 2, the solar laminate 102 has a laminate structure that includes several layers 118. Layers 118 may include for example glass layers, non-reflective layers, electrical connection layers, n-type silicon layers, p-type silicon layers, and/or backing layers. In other embodiments, solar laminate 102 may have more or fewer layers 118, including only one layer, or may have different layers 118, and/or may have different types of layers 118. The solar laminate 102 includes a plurality of solar cells (not shown), each of which converts solar energy to electrical energy. The outputs of the solar cells are connected in series and/or parallel to produce the desired output voltage and current for the solar laminate 102.

As shown in FIG. 1, the frame 104 circumscribes the solar laminate 102. The frame 104 is coupled to the solar laminate 102, as best seen in FIG. 2. The frame 104 assists in protecting the edges 110 of the solar laminate 102. In this embodiment, the frame 104 is constructed of four frame members 120. In other embodiments the frame 104 may include more or fewer frame members 120.

This frame 104 includes an outer surface 130 spaced apart from solar laminate 102 and an inner surface 132 adjacent solar laminate 102. The outer surface 130 is spaced apart from and substantially parallel to the inner surface 132. In this embodiment, the frame 104 is made of aluminum. More particularly, in some embodiments the frame 104 is made of 6000 series anodized aluminum. In other embodiments, the frame 104 may be made of any other suitable material providing sufficient rigidity including, for example, rolled or stamped stainless steel, plastic, or carbon fiber.

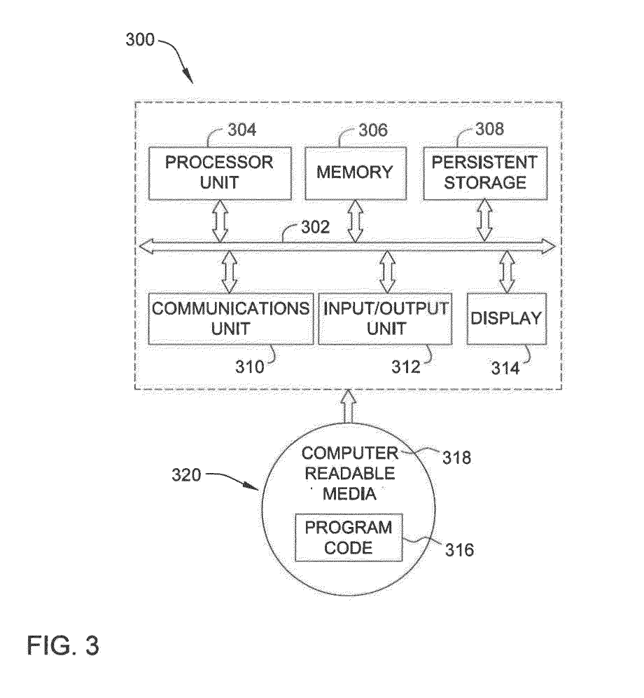

Some exemplary methods and systems are performed using and/or include computing devices. FIG. 3 is a block diagram of an exemplary computing device 300 that may be used. In the exemplary implementation, computing device 300 includes communications fabric 302 that provides communications between a processor unit 304, a memory 306, persistent storage 308, a communications unit 310, an input/output (I/O) unit 312, and a presentation interface, such as a display 314. In addition to, or in alternative to, the presentation interface may include an audio device (not shown) and/or any device capable of conveying information to a user.

Processor unit 304 executes instructions for software that may be loaded into a storage device (e.g., memory 306). Processor unit 304 may be a set of one or more processors or may include multiple processor cores, depending on the particular implementation. Further, processor unit 304 may be implemented using one or more heterogeneous processor systems in which a main processor is present with secondary processors on a single chip. In another implementation, processor unit 304 may be a homogeneous processor system containing multiple processors of the same type.

Memory 306 and persistent storage 308 are examples of storage devices. As used herein, a storage device is any tangible piece of hardware that is capable of storing information either on a temporary basis and/or a permanent basis. Memory 306 may be, for example, without limitation, random access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and/or any other suitable volatile or non-volatile storage device. Persistent storage 308 may take various forms depending on the particular implementation, and persistent storage 308 may contain one or more components or devices. For example, persistent storage 308 may be one or more hard drives, flash memory, rewritable optical disks, rewritable magnetic tapes, and/or some combination of the above. The media used by persistent storage 308 also may be removable. For example, without limitation, a removable hard drive may be used for persistent storage 308.

A storage device, such as memory 306 and/or persistent storage 308, may be configured to store data for use with the processes described herein. For example, a storage device may store (e.g., have embodied thereon) computer-executable instructions, executable software components, PV system component data, PV system layouts, installation instructions, work orders, and/or any other information suitable for use with the methods described herein. When executed by a processor (e.g., processor unit 304), such computer-executable instructions and/or components cause the processor to perform one or more of the operations described herein.

Communications unit 310, in these examples, provides for communications with other computing devices or systems. In the exemplary implementation, communications unit 310 is a network interface card. Communications unit 310 may provide communications through the use of either or both physical and wireless communication links.

Input/output unit 312 enables input and output of data with other devices that may be connected to computing device 300. For example, without limitation, input/output unit 312 may provide a connection for user input through a user input device, such as a keyboard and/or a mouse. Further, input/output unit 312 may send output to a printer. Display 314 provides a mechanism to display information, such as any information described herein, to a user. For example, a presentation interface such as display 314 may display a graphical user interface, such as those described herein.

Instructions for the operating system and applications or programs are located on persistent storage 308. These instructions may be loaded into memory 306 for execution by processor unit 304. The processes of the different implementations may be performed by processor unit 304 using computer implemented instructions and/or computer-executable instructions, which may be located in a memory, such as memory 306. These instructions are referred to herein as program code (e.g., object code and/or source code) that may be read and executed by a processor in processor unit 304. The program code in the different implementations may be embodied in a non-transitory form on different physical or tangible computer-readable media, such as memory 306 or persistent storage 308.

Program code 316 is located in a functional form on non-transitory computer-readable media 318 that is selectively removable and may be loaded onto or transferred to computing device 300 for execution by processor unit 304. Program code 316 and computer-readable media 318 form computer program product 120 in these examples. In one example, computer-readable media 318 may be in a tangible form, such as, for example, an optical or magnetic disc that is inserted or placed into a drive or other device that is part of persistent storage 308 for transfer onto a storage device, such as a hard drive that is part of persistent storage 308. In a tangible form, computer-readable media 318 also may take the form of a persistent storage, such as a hard drive, a thumb drive, or a flash memory that is connected to computing device 300. The tangible form of computer-readable media 318 is also referred to as computer recordable storage media. In some instances, computer-readable media 318 may not be removable.

Alternatively, program code 316 may be transferred to computing device 300 from computer-readable media 318 through a communications link to communications unit 310 and/or through a connection to input/output unit 312. The communications link and/or the connection may be physical or wireless in the illustrative examples. The computer-readable media also may take the form of non-tangible media, such as communications links or wireless transmissions containing the program code.

In some illustrative implementations, program code 316 may be downloaded over a network to persistent storage 308 from another computing device or computer system for use within computing device 300. For instance, program code stored in a computer-readable storage medium in a server computing device may be downloaded over a network from the server to computing device 300. The computing device providing program code 316 may be a server computer, a workstation, a client computer, or some other device capable of storing and transmitting program code 316.

Program code 316 may be organized into computer-executable components that are functionally related. Each component may include computer-executable instructions that, when executed by processor unit 304, cause processor unit 304 to perform one or more of the operations described herein.

The different components illustrated herein for computing device 300 are not meant to provide architectural limitations to the manner in which different implementations may be implemented. The different illustrative implementations may be implemented in a computer system including components in addition to or in place of those illustrated for computing device 300. For example, in some embodiments, computing device includes a global positioning system (GPS) receiver. Moreover, components shown in FIG. 3 can be varied from the illustrative examples shown. As one example, a storage device in computing device 300 is any hardware apparatus that may store data. Memory 306, persistent storage 308 and computer-readable media 318 are examples of storage devices in a tangible form.

In another example, a bus system may be used to implement communications fabric 302 and may include one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, without limitation, memory 306 or a cache such as that found in an interface and memory controller hub that may be present in communications fabric 302.

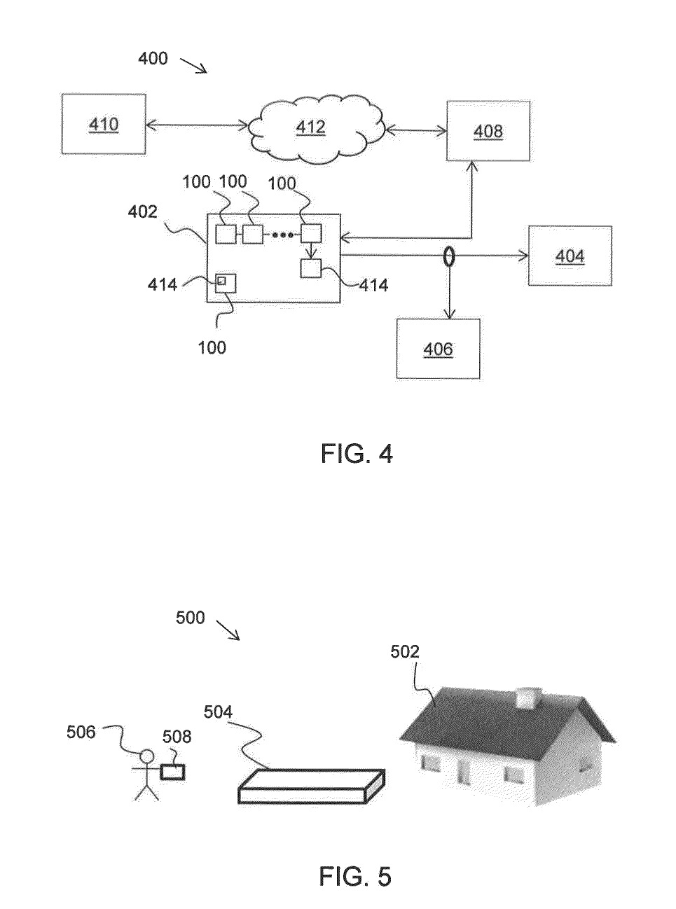

FIG. 4 is a block diagram of an exemplary PV system 400. The PV system 400 includes an array 402 of PV modules 100 and one or more inverters. The array 402 outputs AC power to one or more loads 404. A meter 406 measures the power delivered to the loads 404. A gateway 408 monitors the array 402 and transmits data collected from the array 402 to a backend system 410 via a network 412.

The array 402 may be any suitable array of PV modules 100 and one or more inverters 414. For example, the array 402 may include a plurality of PV modules arranged in strings of PV modules. Each string of modules is connected to a single inverter to convert the DC output of the string of PV modules to an AC output. Alternatively, or additionally, each PV module may be coupled to its own inverter 414 (sometimes referred to as a microinverter) positioned near or on the PV module to which it is electrically coupled. In still other examples, a plurality of strings of PV modules may be connected, directly or through one or more string combiners, to a single inverter 414, sometimes referred to as a central or string inverter.

In embodiments that do not include microinverters, the array 402 may include a direct current power manager (DCPM) coupled to each PV module. The DCPM performs, for example, maximum power point tracking (MPPT) for the PV module. It may also selectively control (i.e., limit and/or increase) the maximum power output of the PV module and/or control the conduction of bypass diodes based on temperature and bypass current. The DCPM may also translates the output I-V curve of the PV module to a new I-V curve at which the output voltage does not vary with ambient temperature.

In some embodiments, the array 402 include one or more tracking devices configured to selectively position the PV modules relative to the sun to attempt to maximize the solar energy incident on the PV modules over time. Any other suitable arrangement of PV modules and inverter(s) may be used, including combinations of the arrangements described above.

The gateway 408 collects data concerning array 402, such as via one or more sensors (no shown). The collected data may include any appropriate operational, situational, environmental, or other data related to the operation and/or condition of the array 402. For example, the gateway may monitor the ambient air temperature around the array 402, the amount of sunlight incident on the array 402 (or one or more PV module), the output voltage and current of the array 402, the output voltage and current of each PV module, etc. Moreover, in some embodiments, the gateway 408 is in communication with one or more components of the array 402. For example, the gateway 408 may be in communication with one or more inverters 414 in the array 402. Each inverter 414 may provide the gateway 408 with, for example, its input voltage, its input current, its output voltage, its output current, etc. In some embodiments, the array 402 (and more particularly the inverters 414) may be controlled via the gateway 408.

In one example, the network 412 is the Internet. In other implementations, network 412 is any other suitable communication network, including, for example, a wide area network (WAN), a local area network (LAN), a cellular network, etc. Network 412 may include more than one network. For example, gateway 408 may connect to the Internet through one or more other networks and/or interfaces, such as a local area network (LAN), a wide area network (WAN), a home area network (HAN), dial-in-connections, cable modems, and high-speed ISDN lines.

FIG. 5 is a diagram of an example site 500 at which installation of a PV system (such as PV system 400) is to occur. The site 500 includes a building 502 on which the PV modules of the PV system will be installed. In residential installations, the building 502 may be a house, a garage, a shed, etc. In other installations, the building 502 may be a commercial building or any other suitable type of building. In still other implementations, the site 500 does not include any buildings and/or the PV system 400 is not installed on any buildings at the site 500. A bundle 504 includes all of the PV components to be installed at the site 500 as part of the site's PV system. An installer 506 is located at the site 500 to install the PV system from the bundle 504. The installer 506 has a computing device 508 for use in installing the PV system at the site 500. The computing device 508 is configured, e.g., programmed, to perform one or more steps of a method of installation of a PV system as described in more detail below. The computing device 508 may be any suitable computing device operable as described herein (including computing device 300). In some embodiments, computing device 508 may be and/or include a laptop computer, a tablet computer, a mobile phone, a barcode scanner, etc.

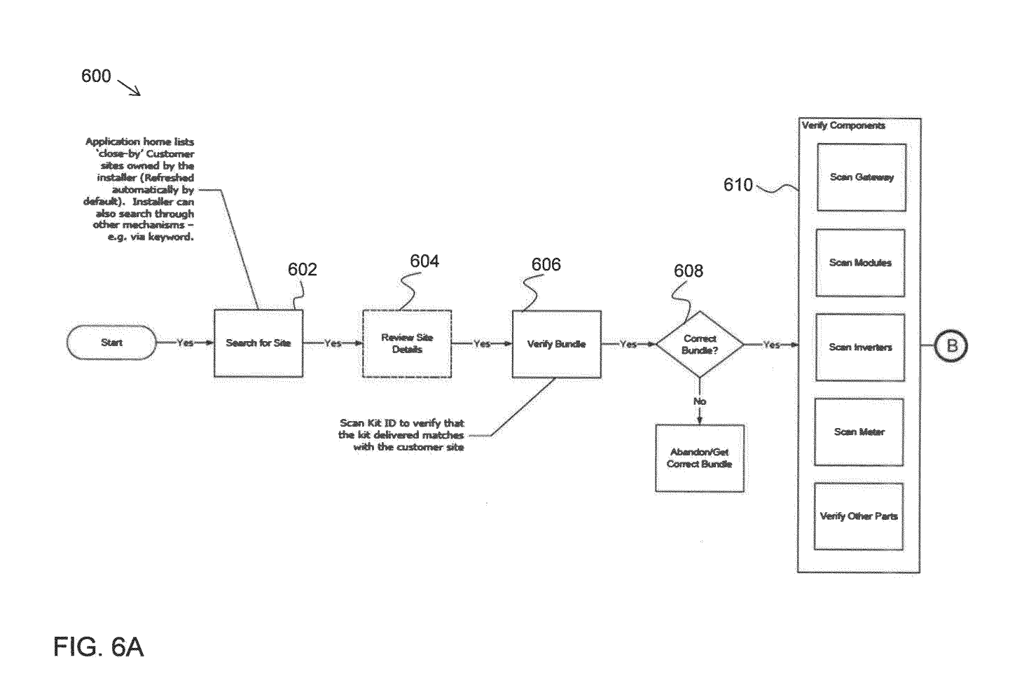

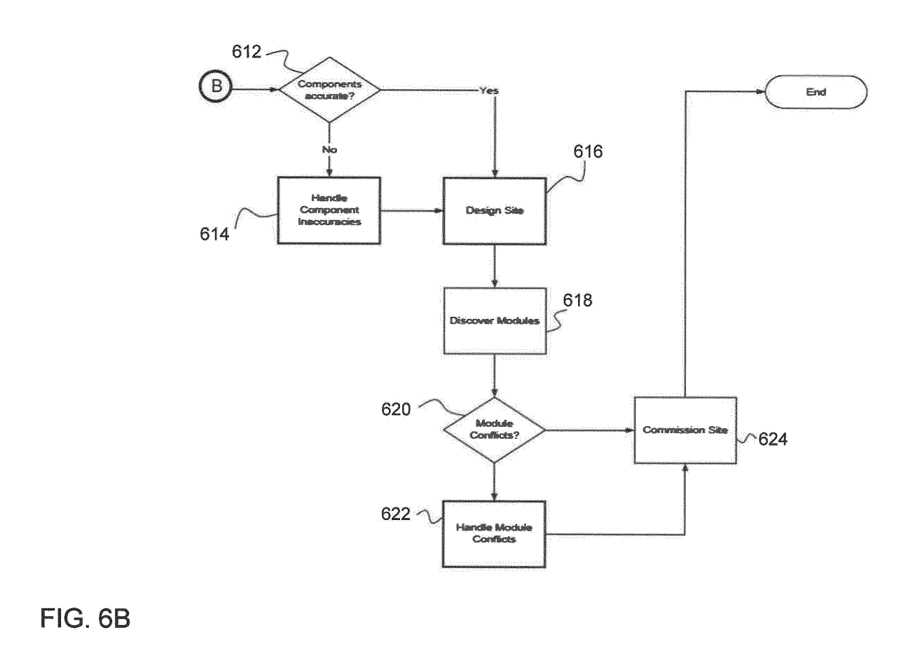

FIGS. 6A and 6B are a flow diagram of an example method 600 of installing a PV system. The method will be described with reference to installing system 400 (shown in FIG. 4) at PV site 500 (shown in FIG. 5) using computing device 508. One or more steps of the method 600 are implemented in one or more applications running on computing device 508. The steps may be embodied in a computer program, application, or the like, running on the computing device 508. The program guides the installer through the process of installing PV systems as described herein and allows the installation and commissioning of PV systems without requiring human interaction between the installer and operator(s) of the backend system 410. Generally, the installer may override or ignore any steps presented via the computing device 508.

At 602, the installer 506 searches for an installation site using computing device 508. In an exemplary embodiment, the computing device 508 determines the location of the installer 506 and searches for the nearest PV site at which installation is required. Alternatively, the computing device 508 displays all PV sites needing installation that are within a selected radius of the installer, displays all PV sites that the installer is eligible to install, displays all PV sites that meet a selected criteria (e.g., include a particular keyword), and/or displays available PV sites for installation based on any other suitable criteria or criterion. Moreover, the PV sites available to the installer 506 may be limited and/or selected by another party, such as an employer, PV system retailer, customer, etc.

After the installer 506 selects the PV site (e.g., site 500), at 604 the site details are displayed to the installer 506 on the computing device 508. The site details may include any suitable details about the particular site 500. For example, the location of the PV site 500 will be displayed, the type of installation (e.g., residential, commercial, distributed generation, etc.), the number and type of PV panels and other components, the arrangement of the PV array, etc.

At 606, the installer 506 verifies the bundle 504 of PV components that has been delivered to the site 500. The bundle 504 of components is identified by a unique identifier (e.g., a serial number). The unique identifier is physically coupled to the bundle. In the exemplary embodiment, the unique identifier is displayed as a barcode (e.g., a matrix barcode, a UPC barcode, etc.) on a label attached to the bundle 504. The installer 506 scans the barcode with the computing device 508 to retrieve the unique identifier. The barcode may be scanned using the computing device 508 directly (such as by using a built in camera or other optical scanner), or using a separate scanning device (e.g., a handheld scanner coupled to the computing device). In some embodiments, the unique identifier may be a number or other identifier (without an associated barcode) printed on a label attached to the bundle 504, a unique identifier encoded in another machine readable, optical identifier, may be stored in an RFID tag attached to the bundle 504, or any other suitable association of a unique identifier with the bundle 504. Alternatively, the unique identifier may be human readable text read by the computing device using optical recognition technology.

At 608, the computing device 508 compares the retrieved unique identifier to the unique identifier associated with the bundle 504 for the particular site 500. If the unique identifier is correct, the installation proceeds. If the identifier is incorrect, the wrong bundle was delivered to the site 500, the installer is at the wrong location/site, and/or the bundle 504 was mislabeled. The installer determines why the identifier for the bundle 504 does not match the expected bundle and attempts to remedy the error, e.g., by retrieving the correct bundle, confirming that the bundle is mislabeled, going to the correct location/site, or installing the bundle at the current site and updating the bundle for this site to be the one being installed.

Once the installer 506 confirms that the correct bundle 504 is present at the site 500 or determines to use of the current bundle (even if it is not the expected bundle) at this site 500, at 610, the installer 506 checks that all of the components that are supposed to be in the bundle 504 are actually present in the bundle 504. The bundle 504 includes, for example, the gateway 408, the PV modules 100, the inverter(s) 414, the meter 406, any required mounting structures and hardware, and any other components needed to assemble PV system 400. Like the bundle 504, each component in the bundle has a unique identifier (e.g., a serial number). The installer scans all of the items in the bundle 504 to acquire the unique identifier of each component. Moreover, components that are connected together and each include a unique identifier (such as a PV module and its associated microinverter 414 or DCPM) are associated with each other in the computing device 508 during/by this scanning. The associated components and their unique identifiers are provided to the gateway 408 and/or the backend system 410.

With reference now to FIG. 6B, at 612 the computing device 508 compares the retrieved unique identifiers to the unique identifiers associated with components that are supposed to be included in the bundle 504. The computing device 508 alerts the installer 506 of any discrepancies between the expected components and the scanned components, which the installer may then remedy at 614. If there are no component inaccuracies, the installer continues the installation. If there are inaccuracies, the installer may attempt to correct the inaccuracies. For example, the installer may retrieve or otherwise supply missing components, confirm all components were accurately scanned/identified, modify the design to need only the components that are present, and/or add or remove components (and their associated identifiers) from the design of the system.

At 616, the installer designs, or maps, the site 500. Generally, the specific layout and organization of the system 400 to be installed at the site 500 is designed before installation (such as by operators of the backend system 410, the PV module manufacturer, PV system retailer, distributor, etc.) and is not within the scope of the installer's duties. Alternatively, the installer may design the layout and organization of the system 400 and/or modify the previously created design. The layout of the system 400 is downloaded to the installer's computing device 508. At 616, the installer 506 records the actual installation (whether before or after physical installation) of the site 500 by indicating which specific component (i.e., which unique identifier) is being used for each component in the system 400. Thus, for example, the installer assigns PV module “A” as the first PV module in a first string of PV modules, and assigns PV module “B” as the second PV module in the first string. Similarly, inverter “A1” may be assigned as the string inverter for the first string, while inverter “A2” is assigned as the string inverter for the second string. The assignment of unique identifier to layout component may be accomplished by dragging and dropping the unique identifiers to their assigned components, or by any other suitable manner of assigning identifiers to components in a layout.

The installer 506 physically installs the PV components at the site 500 to create the system 400. The installer may complete the physical installation before recording the site as described above to match the physical installation, or may record the site as described above and then physically install the components to match the design.

After the site 500 has been recorded and the components are physically installed, the installer 506 connects the computing device 508 to the gateway 408. The computing device 508 may be connected to the gateway 408 with any suitable wired or a wireless connection. The installer 506 provides, via the computing device 508, authentication (e.g., username, SSID, and/or password) to the gateway 408. Unless the correct login parameters are received, the gateway 408 will not permit communicative connection between the computing device 508 and the gateway 408. In one example, the computing device 508 connects to the gateway 408 via a Wi-Fi connection. Alternatively, the computing deice 508 connects to the gateway 408 via Ethernet, Bluetooth, Zigbee, or any other suitable wired or wireless connection. The gateway 408 also establishes a communications link with the backend system 410 via network 412. In the example embodiment, the gateway connects to the backend system via a general packet radio service (GPRS) cellular communication connection. Alternatively, the connection may be via any suitable wired or wireless connection.

The installer 506 uploads the mapped site 500 (e.g., the physical layout and which unique identifier is associated with each component in the layout) to the gateway 408. Alternatively, the installer uploads the designed site data to the backend system 410, from which it is downloaded to the gateway 408. Instructions for communication with the devices in the system 400 are downloaded from the backend system 410 to the gateway 408. At 618, the computing device 508 instructs the gateway 408 to begin local initialization of the system 400, by searching for the connected communication capable components identified in the uploaded design. In this self-test of the system 400, the gateway 408 searches for the inverters 414, DCPMs, and/or other communications capable devices connected to the system 400. In some implementations, the gateway 408 assigns each inverter 414 a unique communication address that is used for communication between the gateway 408 and the inverter 414. In one example, the assigned address is a Modbus address. Alternatively, the assigned address may be an address under any other suitable wired or wireless communication protocol, including RF communication. The assignment may be initiated automatically by the gateway 408, or may be initiated by the gateway 408 in response to an instruction from the installer or the computing device 508. The computing device 508 confirms that the gateway 408 has successfully communicated with the devices of the system 400. If the computing device 508 determines at 620 that there are any conflicts (such as not being able to locate a device, locating a device that is not identified in the uploaded data, etc.) between the uploaded data and the modules/inverters that it has located, the computing device 508 informs the installer 506 and the installer 506 attempts, at 622 to resolve the conflicts. In some embodiments, the installation may not continue until the gateway 408 completes a successful test and informs the computing device 508 of the success. Alternatively, the installer 506 may be permitted to override the prohibition. Once any conflicts are resolved at 620 and/or 622 (or the installer 506 elects to proceed without a successful self-test), the configuration of the system 400 (including unique identifiers and mapped locations) is saved in the gateway 408 and the configuration data is uploaded from the gateway 408 to either the backend system 410 or the computing device 508, which in turn uploads the configuration data to the backend system 410.

After all of the conflicts have been resolved, the gateway 408 is capable of communicating with the components of the system 400 and the backend system 410. The PV system is then ready to be commissioned for use at 624. The installer 506 uses the computing device 508 to inform the gateway 408 that the installation is completed and disconnect the computing device 508 from the gateway 408. The gateway 408 disables future communication with the computing device 508. In some embodiments, future communication with the computing device is disabled by the gateway 408 changing the required login parameters without providing the changed login parameters to the computing device 508.

The system 400 may then begin operation to produce electrical energy from solar energy. The gateway 408 will monitor the system 400 and transmit data to the backend 410. Initially, the communication between the gateway 408 and the backend 410 will be through the same communication method used during installation. Typically, the communication method will be changed as part of the installation or by the customer after installation. In some embodiments, for example, the gateway 408 is configured (by the installer 506 or the customer) to connect to the customers computer network (e.g., to connect to a wired or wireless router in the customers LAN).

In one embodiment, the installer 506 guides the customer through configuring the gateway 408 to connect to the customer's network using the computing device 508. Before disconnecting the computing device 508 from the gateway 408, the installer 506 accesses (using the computing device) the networking configuration in the gateway 408 and guides the customer through inputting the network information (e.g., SSID, password) needed to establish a connection between the gateway 408 and the customer's network. In other embodiments a wired connection is used between the gateway 408 and the network. In such embodiments, connecting to the customer's network may simply involve extending a cable from the gateway 408 to a router or other connection point (e.g., Ethernet port, switch, or hub) of the customer's network.

Alternatively, the customer may configure the gateway 408 to connect to the customer's network. In some embodiments, the customer is provided a website address through which the customer can establish a connection to the gateway 408 to enable the customer to enter the required network information (e.g., SSID and password). However the initial connection is made, once the connection to the customer's network is established, the gateway 408 uses the customer's network (and particularly the customer's connection to the Internet) to communicate with the backend system 410.

A technical effect of the method, device, and system described herein may include one or more of: (a) receiving plurality of unique identifiers associated with a plurality of PV components located at a site; (b) adding or deleting a plurality of PV components along with their associated identifiers; (c) comparing the received unique identifiers to a list of the plurality of PV components in the PV system; (d) associating each of the unique identifiers with a different component location on a representation of the PV system; and (e) transmitting the associated unique identifiers and component locations to a gateway device of the PV system.

The methods and systems of the present disclosure provide a fast, efficient, lower error method for installation and provisioning of PV systems. Components of the PV system are identified by scanning barcodes or RFID tags. The identified parts are compared to the expected parts for the particular site by a computing device to ensure that the correct parts are present to complete the installation. Moreover, the identified parts are associated with particular component locations by the installer on a representation of the PV system using the computing device. This information is then uploaded to a gateway for use in locating and identifying the components of the PV system. These features reduce installation errors and wasted time due to, among other things, wrong components being installed, missing components, incorrect part numbers being noted by the installer, failure by the installer to note the serial number of a component, phone calls to a backend system to provide installation information, etc. As a result, the methods and systems described herein result in faster installations of PV systems with fewer errors and inconveniences, cost saving for the installer and the end user.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

1. A method for installing a photovoltaic (PV) system including a plurality of PV components, the method comprising:
receiving, by a computing device, a plurality of unique identifiers, each unique identifier associated with a different one of a plurality of PV components located at a site;
comparing, by the computing device, the received unique identifiers to a list of the plurality of PV components in the PV system;
associating each of the unique identifiers with a different component location on a representation of the PV system; and
transmitting the associated unique identifiers and component locations to a gateway device of the PV system.

2. The method of claim 1, further comprising instructing, by the computing device, the gateway device to attempt to locate and identify at least one communication capable component of the plurality of components of the PV system based on the associated unique identifiers and component locations, and generating, by the computing device, a notification if the gateway device is unable to locate or identify the at least one communication capable component.

3. The method of claim 2, further comprising changing, by the computing device, at least one of the representation of the PV system, the unique identifier associated with at least one communication capable PV component, and the unique identifier associated with a component location on the representation of the PV system, if the gateway device is unable to locate or identify the at least one communication capable component.

4. The method of claim 2, further comprising assigning, by the gateway device, unique communication addresses to all of at least one type of communication capable PV component in the PV system.

5. The method of claim 1, further comprising instructing, by the computing device, the gateway device to run a self-test of the PV system after the plurality of PV components are assembled according to the representation of the PV system and the associated unique identifiers and component locations, and receiving, by the computing device, a notification from the gateway device indicating whether or not the self-test was successful.

6. The method of claim 5, further comprising preventing provisioning of the PV system until the computing device receives a notification from the gateway device that the self-test was successful.

7. The method of claim 1, further comprising receiving, by the computing device, the representation of the PV system from a remote computing device, wherein the representation of the PV system maps physical and electrical configurations of the plurality of PV components of the PV system and is editable using the computing device.

8. The method of claim 1, further comprising receiving, from a remote computing device, the list of the plurality of PV components in the PV system, and editing the list of the plurality of PV components in the PV system.

9. The method of claim 1, wherein installing the PV system occurs without human interaction between an installer of the PV system and an operator of a backend system to which the PV system is communicatively coupled.

10. The method of claim 1, wherein the plurality of PV components located at the site includes a plurality of PV modules and a plurality of secondary components, each secondary component associated with a different one of the PV modules, the method further comprising associating the unique identifier of each PV module with the unique identifier of its associated secondary component, wherein the secondary components comprise one of microinverters and direct current power managers.

11. The method of claim 10, further comprising transmitting, by the computing device, the unique identifiers of each PV module and its associated secondary component to the gateway device.

12. The method of claim 1, further comprising establishing a communication connection between the computing device and the gateway device and disabling communication between the computing device and the gateway device after the PV system is installed and determined to be ready for operation.

13. The method of claim 12, wherein disabling communication comprises disabling future communication between the computing device and the gateway device.

14. A computing device for facilitating installing a photovoltaic (PV) system including a plurality of PV components, the computing device comprising a processor and a memory coupled to the processor, wherein the memory comprises computer-executable instructions that, when executed by the processor, cause the computing device to:
receive a plurality of unique identifiers, each unique identifier associated with a different one of a plurality of PV components located at a site;
compare the received unique identifiers to a list of the plurality of PV components in the PV system;
associate each of the unique identifiers with a different component location on a representation of the PV system; and
transmit the associated unique identifiers and component locations to a gateway device of the PV system.

15. The computing device of claim 14, wherein the memory further comprises computer-executable instructions that, when executed by the processor, cause the computing device to receive, from a remote computing device, a list of the plurality of PV components in the PV system.

16. The computing device of claim 14, wherein the memory further comprises computer-executable instructions that, when executed by the processor, cause the computing device to:
receive a unique bundle identifier associated with the plurality of PV components located at the site; and
compare the received unique bundle identifier to an expected unique bundle identifier for the site.

17. The computing device of claim 14, wherein the memory further comprises computer-executable instructions that, when executed by the processor, cause the computing device to instruct the gateway to attempt to locate and identify at least one component of the plurality of components of the PV system based on the associated unique identifiers and component locations.

18. The computing device of claim 17, wherein the memory further comprises computer-executable instructions that, when executed by the processor, cause the computing device to generate a notification if the gateway is unable to locate or identify any of the at least one component.

19. The computing device of claim 14, wherein the memory further comprises computer-executable instructions that, when executed by the processor, cause the computing device to receive the representation of the PV system from a remote computing device, wherein the representation of the PV system maps physical and electrical configurations of the plurality of PV components of the PV system.

20. A computer-readable storage device having non-transitory, computer-executable instructions embodied thereon, wherein when executed by a computing device comprising a processor and a memory coupled to the processor, the computer-executable instructions cause the computing device to:
receive a plurality of unique identifiers, each unique identifier associated with a different one of a plurality of PV components located at a site;
compare the received unique identifiers to a list of the plurality of PV components in the PV system;
associate each of the unique identifiers with a different component location on a representation of the PV system; and
transmit the associated unique identifiers and component locations to a gateway device of the PV system.

21. The computer-readable storage device of claim 20, further comprising computer-executable instructions that cause the computing device to receive, from a remote computing device, a list of the plurality of PV components in the PV system.

22. The computer-readable storage device of claim 20, further comprising computer-executable instructions that cause the computing device to:
receive a unique bundle identifier associated with the plurality of PV components located at the site; and
compare the received unique bundle identifier to an expected unique bundle identifier for the site.

23. The computer-readable storage device of claim 20, further comprising computer-executable instructions that cause the computing device to instruct the gateway to attempt to locate and identify at least one component of the plurality of components of the PV system based on the associated unique identifiers and component locations.

24. The computer-readable storage device of claim 23, further comprising computer-executable instructions that cause the computing device to generate a notification if the gateway is unable to locate or identify any of the at least one component.

25. The computer-readable storage device of claim 20, further comprising computer-executable instructions that cause the computing device to receive the representation of the PV system from a remote computing device, wherein the representation of the PV system maps physical and electrical configurations of the plurality of PV components of the PV system.

26-97. (canceled)
